(19) United States
(12) Patent Application Publication
(10) Pub. No.: US 2024/0218088 A1
(43) Pub. Date: Jul. 4, 2024

(54) METAL COMPLEX CATALYST FOR THE POLYMERIZATION OF OLEFINS

(71) Applicant: ARLANXEO NETHERLANDS B.V., RD Geleen (NL)

(72) Inventors: Niklas Christopher STRUCH, Koeln (DE); Victor Fidel QUIROGA-NORAMBUENA, Lanaken (BE); Nikky RITTERBEEKS, Geleen (NL)

(73) Assignee: ARLANXEO NETHERLANDS B.V., RD Geleen (NL)

(21) Appl. No.: 18/288,648

(22) PCT Filed: Apr. 28, 2022
(86) PCT No.: PCT/EP2022/061313

§ 371 Date: Oct. 27, 2023

(30) Foreign Application Priority Data
Apr. 30, 2021 (EP) 21171581.8

(51) Int. Cl. C08F 4/76; C08F 210/16

(52) U.S. Cl. CPC C08F 4/76; C08F 210/16

(57) ABSTRACT

A catalyst composition for polymerizing olefinic monomers comprising a metal complex of formula (I)

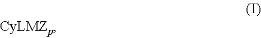

wherein
Cy represents a ligand that is bonded to M and has an optionally substituted cyclopentadienyl unit,
M is a group 4 metal,
Z is an anionic ligand,
p is 1 or 2, and
L is an amidinate ligand of the formula (II)

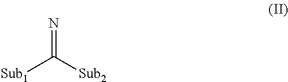

wherein L is covalently bonded to M via the imine nitrogen atom and Sub₁ represents either an aliphatic and cyclic or an aromatic substituent and Sub₂ has the formula (III)

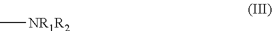

wherein R₁ and R₂ are independently selected from acyclic saturated aliphatic hydrocarbon residues and wherein the hydrocarbon chain of R₁ or R₂ may be interrupted by one or more oxygen atoms or nitrogen atoms. Also provided are a process of making polymers using the composition and the polymers obtained.

The present disclosure relates to metal complexes for the polymerization of olefins, a polymerization process to make olefin polymers and to polymers obtained by the process.

### BACKGROUND

The polymerization of olefins with metallocene catalysts or post metallocene catalysts is well known. For example, the cyclopentadienyl amido catalysts described in international patent application WO2005090418A1 allow to produce ethylene/alpha-olefin copolymers having high molecular weights.

However, there is a continuous need to further develop new catalysts for the polymerization of olefins and, in particular, for making ethylene copolymers of high molecular weight, preferably of a molecular weight greater than 200 kg/mol.

### SUMMARY

Therefore, in one embodiment there is provided a catalyst composition comprising a metal complex according to the formula (I)

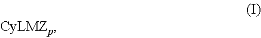

wherein
Cy represents a ligand that is bonded to the metal of the metal complex and the ligand has a cyclopentadienyl unit that is either substituted or unsubstituted,
M is the metal of the metal complex and is selected from a group 4 metal,
Z is selected independently from neutral or anionic ligands bonded to the metal M, wherein the neutral ligands are selected from conjugated dienes having from 4 to 40 carbon atoms which, optionally, may be substituted once or more than once with a substituent selected from the group consisting of hydrocarbyl, silyl, halogenated carbyl and combinations thereof, and wherein the anionic ligands are selected from the group consisting of —H, —F, —Cl, —Br, —I, -pseudohalogen, —C₁₋₁₂-alkyl, —O—C₁₋₁₂-alkyl, —C(═O)C₁₋₁₂-alkyl, -acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, all present in anionic form and combinations thereof,
p is 1 or 2, and
L is an amidinate ligand of the formula (II)

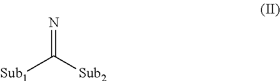

wherein the amidine-containing ligand is covalently bonded to the metal M via the imine nitrogen atom and Sub₁ represent either an aliphatic and cyclic or an aromatic substituent and Sub₁ contains from 6 to 20 carbon atoms and Sub₂ corresponds to the general formula (III)

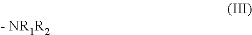

wherein R₁ and R₂ are identical or different and are selected from acyclic, linear or branched, saturated aliphatic hydrocarbon residues having from 4 to 24 carbon atoms and wherein either R₁ and R₂ are both linear or R₁ is linear and R₂ is branched and wherein the hydrocarbon chain of R₁ or R₂ may be interrupted once or more than once by an oxygen atom or a nitrogen atom, or may contain one or more halogen atoms.

In one embodiment R₁ and R₂ are both linear.

In another aspect there is provided a process for preparing a polymer comprising units derived from ethylene wherein the process comprises the steps
(a) providing a monomer composition comprising ethylene;
(b) providing the catalyst composition comprising the metal complex;
(c) contacting at least a fraction of the monomer composition with the catalyst composition to produce a polymer.

In a further aspect there is provided the use of the metal complex as polymerization catalyst for producing a polymer comprising units derived from ethylene.

In another aspect there is provided a polymer obtained with the process.

In yet another aspect there is provided an article comprising a cured polymer wherein the polymer is obtained by the process.

### DETAILED DESCRIPTION

For a complete understanding of the present disclosure and the advantages thereof, reference is made to the following detailed description.

It should be appreciated that the various aspects and embodiments of the detailed description as disclosed herein are illustrative of the specific ways to make and use the disclosure and do not limit the scope of the disclosure when taken into consideration with the claims and the detailed description. It will also be appreciated that features from different aspects and embodiments of the disclosure may be combined with features from different aspects and embodiments of the disclosure.

In the following description the terms “comprising,” “including,” “having,” and their derivatives, are not intended to exclude the presence of any additional component, step or procedure, whether or not the same is specifically disclosed.

In the following description norms may be used. If not indicated otherwise, the norms are used in the version that was in force on Mar. 1, 2020. If no version was in force at that date because, for example, the norm has expired, the version is referred to that was in force at a date that is closest to Mar. 1, 2020.

In the following description the amounts of ingredients of a composition or polymer may be indicated interchangeably by “weight percent”, “wt. %” or “% by weight”. The terms “weight percent”, “wt. %” or “% by weight” are used interchangeably and are based on the total weight of the composition or polymer, respectively, which is 100% unless indicated otherwise.

The term “phr” means parts per hundred parts of rubber, i.e. the weight percentage based on the total amount of rubber which is set to 100%.

Ranges identified in this disclosure include and disclose all values between the endpoints of the range and include the end points unless stated otherwise.

The term “substituted” is used to describe hydrocarbon-containing organic compounds where at least one hydrogen atom has been replaced by a chemical entity other than hydrogen. That chemical entity is referred to herein interchangeably as “substituent”, “residue” or “radical”. For example, the term “a methyl group substituted by fluorine” refers to a fluorinated methyl group and includes the groups —CF₃, —CHF₂ and —CH₂F. The term “unsubstituted” is meant to describe a hydrocarbon-containing organic compound of which none of its hydrogen atoms haven been replaced. For example, the term “unsubstituted methyl group” refers to methyl, i.e. —CH₃.

The catalyst compositions according to the present disclosure contain at least one metal complex as described below. The composition may only contain the metal complex according to the present disclosure or the composition may contain one or more additional ingredients.

### Metal Complexes

The metal complexes according to the present disclosure correspond to formula (I):

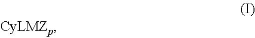

wherein
Cy
M is a group 4 metal
Z is an anionic ligand,
p is 1 or 2, and
L is a ligand of the formula (II)

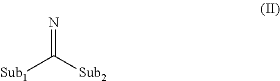

wherein the amidine-containing ligand is covalently bonded to the metal M via the imine nitrogen atom.

Sub₁ is either an aliphatic and cyclic or an aromatic substituent and contains from 6 to 20 carbon atoms.

Preferably Sub₁ represents a substituted or unsubstituted C₆-C₂₀ aryl residue, preferably an unsubstituted phenyl or a substituted phenyl containing one or more substituents selected from halogens, preferably fluorine, and C₁-C₄ alkyls.

In one embodiment Sub₁ is disubstituted, preferably in ortho position.

Specific examples of Sub₁ include but are not limited to 2,6-dimethylphenyl, 2,6-dichlorophenyl or 2,6-difluorophenyl.

Sub₂ corresponds to the general formula (III)

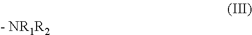

wherein R₁ and R₂ are identical or different and are selected independently from one another from acyclic, linear or branched, saturated aliphatic hydrocarbons having from 4 to 24 carbon atoms and wherein either R₁ and R₂ are both linear or R₁ is linear and R₂ is branched. In one embodiment R₁ or R₂ is interrupted once or more than once by an oxygen atom or a nitrogen atom, or R₁ or R₂ or both contain one or more halogen atoms.

In one embodiment R₁ is selected from n-pentyl, n-hexyl, n-heptyl, n-octyl, n-nonyl, n-decyl, n-undecyl, n-dodecyl and n-tridecyl.

In one embodiment R₁ and R₂ are both linear.

In another embodiment R₁ and R₂ are identical.

### Ligand Cy

The ligands Cy according to formula ((I) are selected from unsubstituted and substituted cyclopentadienyls. Preferably, the substituents are selected independently of one another from the group consisting of N- or S-heterocyclic substituents, C₁₋₂₀-linear, branched or cyclic alkyl substituents, C₆-C₁₂ aryl substituents, and trialkyl silanes. The linear or branched alkyl substituents may be unsubstituted or may be substituted themselves by one or more halogens. The cyclic alkyl substituents, heterocyclic substituents and aryl substituents may be unsubstituted or substituted themselves by one or more halogens, one or more C₁ to C₁₀ linear or branched alkyls, one or more C₁ to C₁₀ linear or branched oxoalkyls, C₅-C₁₀-cycloalkyls, dialkylamino groups which C₁ to C₆ alkyls and combinations thereof.

Examples of C₁-C₂₀ alkyl substituents include but are not limited to —CH₃, —CH₂CH₃, —CH₂CH₂CH₃, —CH(CH₃)₂, —C₄H₉ (including isomers), —C₆H₁₃ (including isomers), or —C₁₀H₂₁ (including isomers), cyclopropyl, cyclobutyl, cyclopentyl, cyclohexyl, phenylcyclohexyl, methylcyclohexyl, cycloheptyl, cyclooctyl, cyclodecyl, cyclododecyl, isopropyldodecyl, adamantyl, norbornyl, tricyclo[5.2.1.0]decyl, fluoromethyl, difluromethyl, methoxymethyl, and trifluoromethyl.

Examples of C₆-C₁₂ aryl substituents include but are not limited to phenyl, or biphenyl (including isomers) and phenyls containing one or more alkyl substituent having from 1 to 6 carbon atoms, for example but not limited to methylphenyl, trimethylphenyl, cyclohexylphenyl, napthyl, butylphenyl, or butyldimethylphenyl. Further examples include, N,N-dimethylaminobenzyl, N,N-dimethylaminomethyl, diphenyl-phosphinomethyl.

Examples of cyclic substituted cyclopentadienyls include unsubstituted indenyl, unsubstituted fluorenyl and substituted indenyl and substituted fluorenyls, wherein the substituents are selected from one or more halogens, one or more C₁ to C₁₀ linear or branched alkyls, C₅-C₁₀ cycloalkyls, dialkylamino groups which C₁ to C₆ alkyls and combinations thereof.

Examples of N- or S-heterocyclic substituted cyclopentadienyls include but are not limited to those corresponding to formula (1) and (2) described below.

A heterocyclic cyclopentadienyl according to formula (1):

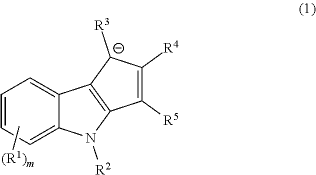

is an indole-fused cyclopentadienyl wherein
R¹ means for each index m individually a C₁-C₄-alkyl that substitutes a hydrogen atom of the benzene ring,
m is a number of 0 to 4, preferably 0 to 2, more preferably 0,
R² means C₁-C₁₀-alkyl, C₅-C₁₀-cycloalkyl, C₆-C₁₀-aryl which is either unsubstituted or substituted with one or more C₁-C₁₀-alkyl groups, one or more C₁-C₄-dialkyl amino groups or a combination thereof,
R³, R⁴ and R⁵ are hydrogen, C₁-C₄-alkyl, or C₆-C₁₀-aryl.

A heterocyclic substituted cyclopentadienyl according to formula (2)

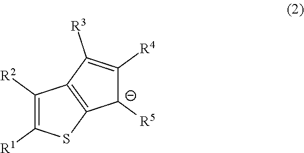

is a thiophene fused cyclopentadienyl wherein
R¹ and R² are selected independently from one another from hydrogen, halogen, C₁-C₁₀ alkyl, C₅-C₁₀ cycloalkyl, and C₆-C₁₀ aryl, or
R¹ and R², together with the 2 double bond carbon atoms of the thiophene ring they are connected to, form an unsubstituted or C₁-C₄ alkyl substituted aliphatic C₅-C₆ cycloalkene ring,
R³, R⁴ and R⁵ are selected independently from each other from hydrogen, C₁-C₄ alkyl, and C₆-C₁₀ aryl.

In one embodiment of the present disclosure Cy is a substituted cyclopentadienyl and contains at least one methyl substituent. In a preferred embodiment of the present disclosure the ligand Cy is selected from cyclopentadienyl, methylcyclopentadienyl, dimethylcyclopentadienyl, trimethylcyclopentadienyl, tetramethylcyclopentadienyl and pentamethylcyclopentadienyl.

### M

The metal M of the metallocene complex of the present disclosure in metal of group 4. For the purpose of this disclosure the term “metal of group 4” refers to conventional IUPAC nomenclature. Preferably, the metal M is selected from the group consisting of titanium, zirconium, and hafnium. In a particularly preferred embodiment of the invention, the metal M is titanium. The metal is in an oxidation state such that the overall metal complex is neutral.

### Ligand Z

In one embodiment of the present disclosure the ligand Z is a neutral ligand and is selected from a conjugated diene. Diene ligands may be associated with the metal M in either an s-trans configuration (π-bound) or in an s-cis configuration (either π-bonded or σ-bonded). Preferably, the conjugated diene contains from 4 to 40 carbon atoms and, optionally, may be substituted with once, or more than once, with substituents independently selected from the group consisting of hydrocarbyl, silyl, halogenated carbyl or a combination thereof. Examples of suitable neural ligands include, but are not limited to, butadiene, isoprene, 1,3-pentadiene, 1,4-diphenyl-1,3-butadiene; 2,3-diphenyl-1,3-butadiene; 3-methyl-1,3-pentadiene; 1,4-dibenzyl-1,3-butadiene; 2,4-hexadiene; 2,4,5,7-tetramethyl-3,5-octadiene; 2,2,7,7-tetramethyl-3,5-octadiene; 1,4-ditolyl-1,3-butadiene; 1,4-bis(trimethylsilyl)-1,3-butadiene; 2,3-dimethylbutadiene.

In preferred embodiments of the present disclosure the ligand Z is anionic. Preferably, the ligand Z is selected from the group consisting of —H, —F, —Cl, —Br, —I, -pseudohalogen, —C₁₋₁₂-alkyl, —O—C₁₋₁₂-alkyl, —C(═O)C₁₋₁₂-alkyl, -acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, and combinations thereof; preferably —C₁₋₁₂-alkyl, wherein these ligands are in their anionic form. For the purpose of the specification, pseudohalogens are polyatomic analogues of halogens, whose chemistry resembles that of the true halogens and allows them to substitute for halogens in several classes of chemical compounds. Suitable examples include, but are not limited to, —CN, —OCN, —SCN or —N₃.

Preferably, the anionic ligand Z is selected from the group consisting of the anions of —CH₃, -benzyl, —Si(CH₃)₃, —CH₂—Si(CH₃)₃, -phenyl, -phenyl substituted with 1, 2, 3, 4 or 5 substituents independently of one another selected from the group consisting of —O—C₁₋₁₂-alkyl, —N(C₁₋₁₂-alkyl)₂, —F, and —Si(C₁₋₁₂-alkyl)₃ such as methoxyphenyl, dimethoxyphenyl, N,N-dimethylaminophenyl, bis(N,N-dimethylamino)phenyl, fluorophenyl, difluorophenyl, trifluorophenyl, tetrafluorophenyl, perfluorophenyl, trimethylsilylphenyl, bis(trimethylsilyl)phenyl, tris(trimethylsilyl)phenyl; preferably Z is a methyl anion.

In one embodiment of the present disclosure, index p is 2 such that the compound comprises two ligands Z and preferably both ligands Z are identical and preferably the two ligands Z are each methyl anions.

In one embodiment of the present disclosure the metal complex corresponds to formula (I) and M is titanium.

In one embodiment of the present disclosure the metal complex corresponds to formula (I) and p is 2 and Z is anionic —CH₃.

In one embodiment of the present disclosure the metal complex corresponds to formula (I) and Cy is selected from methyl cyclopentadienyl, dimethylcyclopentadienyl, trimethylcyclpentadienyl, tetramethlycyclopentadienyl and pentamethylcyclopentadienyl.

In one embodiment of the present disclosure the metal complex corresponds to formula (I) and Sub₁ is phenyl and 2,6-difluorophenyl.

### Polymerizations

Ethylene-containing polymers may be produced by using the catalyst composition according to the present disclosure. The metal complex may be used either alone or in combination with other polymerization catalysts or in combination with one or more optional scavengers and activators a combination thereof.

Therefore, in another aspect of the present disclosure there is provided a process for the preparation of a polymer comprising units derived from ethylene comprising
(a) providing a monomer composition containing ethylene;
(b) providing a catalyst composition comprising at least one metal complex according to the present disclosure,
(c) contacting at least a fraction of the monomer composition with at least a fraction of a catalyst composition to polymerize the monomer composition.

The process may further comprise, optionally, providing at least one scavenger and/or, optionally, providing at least one activator. The activator and scavenger may be a component of a catalyst composition comprising the metal complex of the present disclosure or they may be provided separately, for example as separate feed streams.

The monomer composition may be polymerized to produce polymers that have a broad or narrow molecular weight distribution (Mw/Mn). In one embodiment polymers may be produced that have a molecular weight distribution (Mw/Mn) from 1.80 to 30 or from 2 to 10.

Polymers may be produced that have a high or low Mooney viscosity. In one embodiment the polymer produced by the process has a Mooney viscosity ML 1+4 at 125° C. of at least 40 and up to a Mooney viscosity ML 1+8 at 150° C. of 100. In one embodiment of the present disclosure the polymer has a Mooney viscosity ML 1+4 at 125° C. of about 40 to about 100. In another embodiment of the present disclosure, the polymer has a Mooney viscosity ML 1+8 at 150° C. of from about 50 to about 100.

Polymers of high or low weight average molecular weight (Mw) may be produced by the process according to the present disclosure. In one embodiment the polymer has an (Mw) greater of at least 200,000 g/mol, for example from about 200,000 g/mol to about 600,000 g/mol.

Polymers with a high or low number average molecular weight (Mn) may be produced. In one embodiment the polymer produced by the process according to the present disclosure has an Mn of from 40,000 g/mol to 250,000 g/mol.

Branched or linear polymers may be produced with the process according to the present disclosure. The branching level of branched polymers may be high, moderate or low. The polymer branching level can be characterized by the parameter Δδ. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C. and 10% strain. This quantity Δδ is a measure for the amount of long chain branched structures present in the polymer and has been introduced in H. C. Booij, Kautschuk+Gummi Kunststoffe, Vol. 44, No. 2, pages 128-130, which is incorporated herein by reference. In one embodiment of the present disclosure polymers with a Δδ of from 2 to 65 may be produced.

The polymers produced by the process according to the present disclosure may be monomodal, or they may be bimodal or multimodal. The polymers may have molecular weight distributions featuring two peaks or one peak and one shoulder in case of bimodal polymers or more than two peaks or two shoulders in case of multimodal polymers in a diagram obtained by gel permeation chromatography (GPO). Reactor blends may be produced also, which means polymers are produced in at least two different reaction vessels and are combined by blending, typically wet blending, i.e. by blending the reaction mixtures. Also block-polymers or grafted polymers may be produced.

### Ethylene-Containing Polymers:

The polymers that can be produced by using the catalyst composition according to the present disclosure contain units derived from ethylene and the monomer composition to be provided in the process according to the present disclosure contains at least ethylene. Preferably the polymer produced by the process according to the present disclosure is an ethylene-copolymer and more preferably an ethylene/alpha-olefin copolymer.

### Ethylene/Alpha-Olefin Polymers:

In one embodiment of the present disclosure the polymer produced with the catalyst composition according to the present disclosure is an ethylene/alpha-olefin-polymer. The ethylene/alpha-olefin-polymer is a copolymer of ethylene and at least one other alpha-olefin and, optionally, one or more further comonomers. Ethylene/alpha-olefin polymers can be produced that comprise at least 20% by weight (based on the total weight of the polymer) of units derived from ethylene and may contain up to 80 percent by weight (wt. %) of units derived from ethylene. In one embodiment the ethylene-α-olefin-copolymer of the present disclosure comprises from 40 to 70 wt. %, preferably from 44 to 65 wt % of units derived from ethylene. The weight percentages are based on the total weight of the copolymer.

In addition to units derived from ethylene the polymer according to the present disclosure may contain units derived from one or more other alpha-olefins.

### Alpha-Olefins:

Alpha-olefins are olefins having a single aliphatic carbon-carbon double bond. The double bond is located at the terminal end (alpha-position) of the olefin. The α-olefins can be aromatic or aliphatic, linear, branched or cyclic. Typically, the alpha-olefins have from 3 to 20 carbon atoms.

Alpha-olefins include those represented by the formula: H₂C═X—CH₃,

where X represents an aliphatic alkylene residue having from 1 to 17 carbon atoms which may be linear or branched. Preferably the branches contain, independently from each other, from 1 to 3 carbon atoms.

In a preferred embodiment alpha-olefins include those represented by the formula: H₂C═CH—(CH₂)ₙ—CH₃ where n=represents 1, 2, 3, 4, 5, 6, 7, 8, 9, 10, 11, 12, 13, 14, 15, 16 and 17.

Preferred examples of alpha-olefins include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-hepta-decene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene and 12-ethyl-1-tetradecene.

One or more alpha-olefins may be used in combination. Preferably, the polymer contains at least 5 wt. % or at least 10 wt. % of units derived from one or more alpha-olefin. Polymers may be produced that contain up to 57 wt. %, more preferably up to 55 wt. % of units derived from one or more alpha-olefin (the weight percentages (wt. %) are based on the total weight of the polymer). Preferably, the ethylene-α-olefin-copolymer contains from 17 to 57 wt. % of total units derived from one or more alpha-olefin. Preferably, the polymer contains propylene.

### Non-Conjugated Dienes:

In addition to ethylene and alpha-olefin the ethylene/alpha-olefin polymers may be produced that additionally contain units derived from one or more non-conjugated diene as comonomer.

Non-conjugated dienes are polyenes comprising at least two carbon-carbon double bonds, the double bonds are non-conjugated and may be present in chains, rings, ring systems or combinations thereof. The carbon-carbon double bonds are separated by at least two carbon atoms. The polyenes may have endocyclic and/or exocyclic double bonds and may have no, the same or different substituents. Preferably, the non-conjugated dienes are aliphatic, more preferably aliphatic and alicyclic. Suitable non-conjugated dienes include, for example, aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include but are not limited to 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, dicyclopentadiene, and mixtures thereof.

Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Preferred examples include dicyclopentadiene (DCPD), 5-methylene-2-norbornene and 5-ethylidene-2-norbornene (ENB) with ENB being particularly preferred. In one embodiment the copolymer of the present disclosure contains only ENB as non-conjugated diene. The above dienes typically contain one double bond that takes part in the polymerization while the other double bond may not get polymerized and can thus provide a cure side for curing the polymer

Further examples of non-conjugated dienes include non-conjugated dienes include dual polymerizable dienes, i.e. dienes where both of the non-conjugated double bonds may get polymerized. Such dienes can introduce branching sites into the polymer for the production of long chain branches and may contribute to a branched polymer structure. Examples include but are not limited to vinyl substituted aliphatic monocyclic and non-conjugated dienes, vinyl substituted bicyclic and non-conjugated aliphatic dienes. Such dual polymerizable dienes may cause or contribute to the formation of polymer branches. Examples of aliphatic dual polymerizable dienes include 1,4-divinylcyclohexane, 1,3-divinylcyclohexane, 1,3-divinylcyclopentane, 1,5-divinylcyclooctane, 1-allyl-4-vinylcyclo-hexane, 1,4-diallyl cyclohexane, 1-allyl-5-vinylcyclooctane, 1,5-diallylcyclooctane, 1-allyl-4-isopropenyl-cyclohexane, 1-isopropenyl-4-vinylcyclohexane and 1-isopropenyl-3-vinylcyclopentane, dicyclopentadiene and 1,4-cyclohexadiene. Preferred are non-conjugated vinyl norbornenes and C₈-C₁₂ alpha omega linear dienes (e.g., 1,7-octadiene, 1,8-nonadiene, 1,9-decadiene, 1,10-undecadiene, 1,11-dodecadiene). The dual polymerizable dienes may be further substituted with at least one group comprising a heteroatom of group 13-17 for example O, S, N, P, Cl, F, I, Br, or combinations thereof.

Examples of aromatic non-conjugated polyenes include vinylbenzene (including its isomers) and vinyl-isopropenylbenzene (including its isomers).

In a preferred embodiment of the present disclosure the dual polymerizable diene is selected from dicyclopentadiene (DCPD), 5-vinyl-2-norbornene (VNB), 1,7-octadiene and 1,9-decadiene with 5-vinyl-2-norbornene (VNB) being most preferred.

In a typical embodiment of the present disclosure ethylene/alpha-olefin copolymers can be produced that contain at least 3 wt. % and up to and including 15 wt. % of units derived from the one or more non-conjugated diene.

In another embodiment of the present disclosure polymers are produced that contain non-conjugated dienes selected from, 5-ethylidene-2-norbornene (ENB), 5-vinyl-2-norbornene (VNB), 1,7-octadiene, 1,9-decadiene, dicyclopentadiene (DCPD) or a combination thereof. Preferably, the copolymer of the present disclosure contains from 0.05 wt. % to 5 wt. %, more preferably from 0.10 wt. % to 3 wt. % or from 0.15 wt. % to 1.2 wt. % of units derived from VNB (all weight percentages are based on the total weight of ethylene-α-olefin-copolymer). In another embodiment ethylene/α-olefin-copolymer can be produced that contains units derived from 5-ethylidene-2-norbornene and 5-vinyl-2-norbornene, for example the ethylene/alpha-olefin-copolymers produced may contain from 2 to 15 wt. % of units derived from ENB and from 0.05 to 4 wt. % of units derived from VNB.

The ethylene/α-olefin-copolymers can be produced by the process according to the present disclosure that may or may not contain units derived from other comonomers. The sum of units derived from ethylene, alpha-olefin and, optionally, non-conjugated diene may be greater than 90 wt. %, greater than 99 wt. % and including 100 wt. % based on the total weight of the ethylene/alpha-olefin polymer.

### Chain Transfer Agents:

The polymerization may include the use of one or more chain transfer agents to control the molecular weight of the polymer. A preferred chain transfer agent includes hydrogen (H₂) and diethyl zinc and combinations thereof.

### Activators:

One or more activators, also referred to herein interchangeably as cocatalysts”, may be used in the polymerization. The presence of cocatalysts typically increases the rate at which the catalyst polymerizes the olefins. The cocatalyst can also affect the molecular weight, degree of branching, comonomer content, or other properties of the polymer. The cocatalyst is typically introduced into the reactor together with the catalyst, for example as part of a catalyst composition, but may also be introduced separately, for example in a separate feed stream.

Typical cocatalysts include but are not limited to boron containing activators. In a preferred embodiment the activators (b) are selected from boranes (C1) or borates (C2 or C3).

Suitable boron activators (C1) can be represented by the general formula BQ₁Q₂Q₃.

Suitable borate activator according to (C₂) can be represented by the general formula G(BQ₁Q₂Q₃Q₄).

Suitable borate activators according to (C₃) can be represented by the general formula (J-H)(BQ₁Q₂Q₃Q₄),

In the activator according to (C1) B is boron and Q₁ to Q₃ are substituted or unsubstituted aryl groups, preferably phenyl groups. Suitable substituents include but are not limited to halogens, preferably fluoride, and C₁ to C₄₀ hydrocarbyls, preferably C₁ to C₂₀ alkyls or aromatics. Specific examples of activators according to (C1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, phenyl-bis(pentafluoro-phenyl)borane and the like.

In the activator according to (C2) G is an inorganic or organic cation, B is boron and Q₁ to Q₃ are the same as in (C1) and Q₄ is also a substituted or unsubstituted aryl group, preferably a substituted or unsubstituted phenyl. Substituents include but are not limited to halogens, preferably fluoride, and C₁ to C₄₀ hydrocarbyls, preferably C₁ to C₂₀ alkyls or aromatics. Specific examples for the borate group (BQ₁Q₂Q₃Q₄) include but are not limited to tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, teterakis(2,3,4-trifluorophenyl)borate, phenyltris(pentafluoro-phenyl) borate, tetrakis(3,5-bistrifluoromethylphenyl)borate and the like. Specific examples of G include a ferrocenium cation, an alkyl-substituted ferrocenium cation, silver cation and the like. Specific examples of an organic cation G include a triphenylmethyl cation and the like. G is preferably a carbenium cation, and particularly preferably a triphenylmethyl cation.

In the activator according to (C3) J represents a neutral Lewis base, (J-H) represents a Bronsted acid, B is a boron and both Q₁ to Q₄ and the borate group (BQ₁Q₂Q₃Q₄) are the same as in (C2). Specific examples of the Bronsted acid (J-H) include a trialkyl-substituted ammonium, N,N-dialkylanilinium, dialkylammonium, triaryl phosphonium and the like. Specific examples of activators according to (C3) include but are not limited to triethylammoniumtetrakis(pentafluoro-phenyl)-borate, tripropylammoniumtetrakis(pentafluorophenyl)borate, tri(n-butyl)ammonium-tetrakis(pentafluorophenyl)borate, tri(n-butyl)ammoniumtetrakis(3,5-bistrifluoromethyl-phenyl)borate, N,N-dimethyl-aniliniumtetrakis(pentafluoro-phenyl)borate, N,N-diethylaniliniumtetrakis(penta-fluorophenyl)borate, N,N-2,4,6-pentamethylanilinium-tetrakis(pentafluorophenyl)borate, N,N-dimethylanilinium-tetrakis(3,5-bistrifluoromethyl-phenyl)borate, diisopropyl-ammoniumtetrakis(penta-fluorophenyl)borate, dicyclohexyl-ammoniumtetrakis-(pentafluorophenyl)borate, triphenylphosphoniumtetrakis(penta-fluorophenyl)borate, tri(methylphenyl)phosphoniumtetrakis(pentafluorophenyl)borate, tri(dimethylphenyl)-phosphonium-tetrakis(pentafluorophenyl)borate and the like.

Other cocatalysts include but are not limited to aluminium alkyls such as trialkyl aluminium, trimethyl aluminium, triethyl aluminium, tri-isobutyl aluminium, or tri-n-octylaluminium. Other examples include but are not limited to alkyl aluminium halides, such as diethyl aluminium chloride, dimethyl aluminium chloride, and ethyl aluminium sesquichloride. Further examples include alumoxanes, including methyl alumoxane (MAO), tetraisobutyl alumoxane (TIBAO) or hexaisobutyl alumoxane (HIBAO).

### Scavengers:

Impurities can harm catalysts by reducing their activity. Compounds that react with such impurities and turn them into harmless compounds for catalyst activity are referred to as scavengers by one skilled in the art of polymerization. Scavengers may be used in the process according to the present disclosure. Examples of scavengers include but are not limited to alkyl aluminum compounds, such as trimethyl aluminum, triethyl aluminum, tri-isobutyl aluminum, and trioctyl aluminum. In some cases the scavenger may also act as a cocatalyst. In this case the scavenger is generally applied in excess of what is needed to fully activate the catalyst.

In an embodiments of the process according to the invention, the molar ratio of activator provided in step (c) of the process to the metallocene compound according to the invention as defined above is from 10:1 to 1:1, preferably from 2:1, preferably 1:2.

The scavenger, preferably an aluminum-containing scavenger, can be used in combination with a sterically hindered hydrocarbon or a sterically hindered heterohydrocarbon, preferably a sterically hindered phenol or amine. Specific examples of sterically hindered hydrocarbons and heterohydrocarbons include but are not limited to tert-butanol, iso-propanol, triphenylcarbinol, 2,6-di-tert-butylphenol, 4-methyl-2,6-di-tert-butylphenol, 4-ethyl-2,6-di-tert-butylphenol, 2,6-di-tert-butylanilin, 4-methyl-2,6-di-tert-butylanilin, 4-ethyl-2,6-di-tert-butylanilin, diisopropylamine, di-tert-butylamine, diphenylamine and the like. A preferred sterically hindered compound is 4-methyl-2,6-tertbutyl phenol.

In the process of producing polymers according to the present disclosure the monomer composition is contacted with the catalyst composition according to the present disclosure. Contacting may take place in the gas phase. It may also take place in the presence of one or more solvents, for example in solution or in a slurry. The polymerization may be carried out in solution or slurry under pressure and at temperatures that no gas phase is formed. Preferred solvents include one or more hydrocarbon solvent. Suitable solvents include C₅₋₁₂ hydrocarbons such as pentane, hexane, heptane, octane, cyclohexane, methylcyclohexane, pentamethyl heptane, hydrogenated naphtha, isomers and mixtures thereof.

The process can be carried at reaction temperatures and pressures as known in the art for the polymerization of such polymers. The polymerization may be carried out as solution polymerization or as slurry polymerization or as polymerization in the gas phase. Preferably, the polymerization is carried out as solution polymerization. Typical reaction temperatures include from 20° C. to 150° C. or from 60° C. to 140° C. In one embodiment of the present disclosure the metallocene compounds are used in a polymerization, preferably solution polymerization at reaction temperatures as high as 130° C. and, for example, at suitable pressures to keep the monomers in liquid or dissolved phase.

The catalyst composition may be used alone or in combination with one or more other catalysts other than the metal complexes according to the present disclosure, for example metallocene catalysts, preferably bis-indenyl catalysts.

The polymerization to produce polymers may be carried out in a single reactor or in multiple reactors. The catalyst composition may be added in a first reactor and in another reactor and the catalyst composition may be the same or a different one in the first and the second reactor. The polymerization may be carried out in multiple reactors connected in series or in parallel. In a polymerization in parallel the resulting polymer mixtures can be combined to provide a so-called reactor blend, i.e. a wet blend of two or more polymer compositions.

### Other Aspects of the Disclosure

In another aspect of the present disclosure there is provided a polymer obtainable by the process according to the invention as described above. In one embodiment the polymer is ethylene propylene rubber (EPM) or ethylene propylene diene monomer rubber (EPDM).

In another aspect of the present disclosure there is provided an article that contains the polymer obtained by the process described herein or by the use of the metal complex according to the present disclosure. at least a partially cured polymer. If the polymer is curable, the article preferably contains the polymer in at least partially cured form.

Another aspect of the invention relates to a use of a metal complex according to the present disclosure as polymerization catalyst for polymerizing a monomer composition as defined above.

Another aspect of the present disclosure provides a supported catalyst, which comprises the metal complex or the catalyst composition according to the present disclosure, on a supporting material. The supported catalyst may optionally further contain a scavenger or an activator or a combination of scavenger and activator. The supporting material may be a solid material with a high surface area, to which at least one of the metal complexes of the present disclosure is affixed. Typically, the activity of heterogeneous catalysts occurs at the surface atoms. Consequently, great effort is made to maximize the surface area of a catalyst. One suitable method for increasing surface area involves distributing the catalyst over the supporting material. The supporting material may be inert or participate in the catalytic reactions. Preferably, the supporting material is selected from the group consisting of silica, magnesium halogenides, such as MgF₂, MgCl₂, MgBr₂, MgI₂, zeolites, alumina, polystyrene, polypropylene, polyethylene, polyamides, polyesters and combinations thereof.

### EXAMPLES

The following examples further illustrate the present disclosure without any intention to limit the disclosure to these examples.

### Methods

### Test Methods

### Comonomer Composition

Fourier transformation infrared spectroscopy (FT-IR) can be used to determine the composition of the copolymers according to ASTM D3900 (revision date 2017) for the C2/C3 ratio and D6047 (revision date 2017) for the diene content on pressed polymer films.

### Phase Angle Measurements

The polymer branching can be determined by phase angle measurements on a Montech MDR 3000 moving die rheometer with parameter Δδ. Δδ (expressed in degrees) is the difference between the phase angle δ measured at a frequency of 0.1 rad/s and the phase angle δ measured at a frequency of 100 rad/s determined by Dynamic Mechanical Analysis (DMA) at 125° C. Δδ is a measure for the presence of long chain branches in the polymer structure. The lower the value of Δδ the more long-chain branches are present in the polymer and has been introduced by H. C. Booij, in Kautschuk+Gummi Kunststoffe, Vol. 44, No. 2, pages 128-130, 1991, which is incorporated herein by reference.

Size Exclusion Chromatography with Differential Viscometry (SEC-DV)

The molecular weight distribution (MWD), weight average molecular weight (Mw), number-average molecular weight (Mn), the polydispersity (Mw/Mn) and the intrinsic viscosity can be determined by gel permeation size exclusion chromatography (GPC/SEC). A Polymer Char GPC from Polymer Characterization S. A, Valencia, Spain can be used. The Size Exclusion Chromatograph can be equipped with an online viscometer (Polymer CharV-400 viscometer), an online infrared detector (IR5 MCT) and with 3 AGILENT PL OLEXIS columns (7.5×300 mm) and a Polymer Char autosampler. Universal calibration of the system can be performed with polyethylene (PE) standards.

The polymer samples can be weighed (in the concentration range of 0.3-1.3 mg/ml) into the vials of the PolymerChar autosampler. In the autosampler the vials are filled automatically with solvent (1,2,4-tri-chlorobenzene) stabilized with 1 g/l di-tertbutylparacresol (DBPC). The samples are kept in the high temperature oven (160° C.) for 4 hrs. After this dissolution time, the samples are automatically filtered by an in-line filter before being injected onto the columns. The chromatograph system is operated at 160° C. The flow rate of the 1,2,4-trichlorobenzene eluant is 1.0 mL/min. The chromatograph contains a built-in on-line infrared detector (IR5 MCT) for concentration and a built-in PolymerChar on-line viscometer.

### General Operation Procedures:

All experiments for preparing the metal complexes were carried out using standard Schlenk line or dry-box techniques under an atmosphere of argon or nitrogen. Solvents were degassed by sparging with nitrogen and dried by passing through a column of the appropriate drying agent. Deuterated solvents were dried over CaH₂, distilled under reduced pressure and stored under nitrogen in PTFE valve ampoules. NMR samples were prepared under nitrogen in 5 mm WILMAD 507-PP tubes fitted with J. YOUNG PTFE valves. ¹H, ¹⁹F and ¹³C-{¹H} spectra were recorded at ambient temperature and referenced internally to residual protic-solvent (¹H) or solvent (¹³C) resonances and are reported relative to tetramethylsilane (d=0 ppm). Chemical shifts are quoted in δ (ppm) and coupling constants in Hz. NMR spectra were measured on an Avance 400 spectrometer from BRUKER.

### General Procedures for Making Metal Complexes:

The metal complexes were prepared by reacting the ligands in a protonolysis reaction with the same molar amount of Cp*TiMe₃ at room temperature. The reaction time below two hours. In a typical experiment 5.7 mg of Cp*TiMe₃ (0.025 mmol) were dissolved in 5 ml toluene. The ligand (0.025 mmol) was also dissolved in 5 ml toluene. Both solutions were combined to produce the metal complexes. The resulting solution was diluted with toluene to 25 ml before it was used in the polymerization experiments. The metal complexes were prepared in situ and were used immediately.

Cp*TiMe₃ was prepared by dissolving Cp*TiCl₃ in hexanes and adding a methyllithium solution in diethyl ether. The mixture was stirred for four hours and the solvent was evaporated. The solid was dissolved again, filtered and the solvent was evaporated. The product was dissolved in pentane and stored into a freezer at −80° C. After three days large crystals were formed. The mixture was filtered to obtain the pure material (73%) in high purity (95% by ¹H-NMR).

The ligands were prepared by reacting the respective amines (HN—R₁R₂) with benzonitrile. The reactions were carried out under nitrogen atmosphere with the use of standard Schlenck techniques. The solvents and reagents were dried before use. In a typical reaction 9.58 mmol of benzonitrile in 15 mL of toluene were stirred overnight over calcium hydride to remove moisture after which the calcium hydride was filtered off. A solution of the amine (9.88 mmol) in 10 ml of toluene was prepared separately and a 3 M solution of methyl magnesium chloride in tetrahydrofurane (3.36 ml, 9.78 mmol) was added to it dropwise and under stirring. The resulting mixture was stirred for 1.5 hours at 50° C. The suspension was cooled to room temperature after which the benzonitrile solution was added. The reaction mixture was stirred for 18 hours at 70° C. The reaction mixture was cooled to room temperature and water was added (15 ml) and the reaction was stirred for another hour at room temperature. The organic phase was separated and washed with water (2×15 mL). The aqueous phase was extracted with diethyl ether (3×15 mL). The combined organic phases were dried over magnesium sulphate. The magnesium sulphate was filtered off and the solvent was evaporated. The ligand was an oil and was purified by column chromatography (silica gel with a solution of hexanes and ethylacetate (1:1 v/v) and 1% triethyl amine).

Ligands where Sub1 was 2,6-difluorophenyl were prepared in the same way except that 2,6-difluorobenzonitrile was used instead of benzonitrile.

Various metal complexes of the general structure ((CH₃)₅Cp-Ti—(CH₃)₂)(NC(Sub₁)(Sub₂)) below where Op represents cyclopentadienyl were prepared with different ligands L, i.e. with different residues Sub₁ and Sub₂ respectively as shown in the general formula below and in table 1 below.

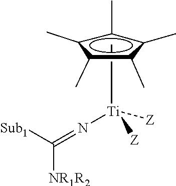

TABLE 1

| Example/ | | |
|---|---|---|
| (Metal complex) | Sub₁ | Sub₂ (—NR₁R₂) |
| Comparative Example 1 | 2,6-difluorophenyl | N,N-di-(2-ethylhexyl)amino |
| (compound CA297) | | R₁ = R₂ = —CHCH₂(C₂H₅)(CH₂)₃CH₃ |
| Comparative Example 2 | phenyl | N,N-di-(2-ethylhexyl)amino |
| (compound CA296) | | R₁ = R₂ = —CHCH₂(C₂H₅)(CH₂)₃CH₃ |
| Comparative Example 3 | 2,6-difluorophenyl | N,N-di-(2-methylpropyl)amino |
| (compound CA288) | | R₁ = R₂ = —CH₂CH(CH₃)₂ |
| Comparative Example 4 | phenyl | N,N-di-(2-methylpropyl) amino |
| (compound CA291) | | R₁ = R₂ = —CH₂CH(CH₃)₂ |
| Example 1 | 2,6-difluorophenyl | N,N-di-(n-octyl)amino |
| (compound CA287) | | R₁ = R₂ = —CH₂(CH₂)₆CH₃ |
| Example 2 | phenyl | N,N-di-(n-octyl)amino |
| (compound CA289) | | R₁ = R₂ = —CH₂(CH₂)₆CH₃ |
| Example 3 | 2,6-difluorophenyl | N-(n-octyl)-N-(1,3-dimethylbutyl)amino |
| (compound CA298) | | R₁ = —CH₂(CH₂)₆CH₃); |
| | | R₂ = —CH(CH₃)CH₂CH(CH₃)CH₃ |
| Example 4 | phenyl | N-(n-octyl)-N-(1,3-dimethylbutyl)amino |
| (compound CA300) | | R₁ = —CH₂(CH₂)₆CH₃); |
| | | R₂ = —CH(CH₃)CH₂CH(CH₃)CH₃ |
| Example 5 | 2,6-difluorophenyl | N-n-butyl-N--1,3-dimethylbutyl)amino |
| (compound CA293) | | R₁ = —CH₂(CH₂)₂CH₃ |
| | | R₂ = —CH(CH₃)CH₂CH(CH₃)CH₃ |
| Example 6 | phenyl | N-n-butyl-N-1,3-dimethylbutyl)amino |
| (compound CA292) | | R₁ = —CH₂(CH₂)₂CH₃ |
| | | R₂ = —CH(CH₃)CH₂CH(CH₃)CH₃ |

### General Procedure for Polymerizations

The polymerizations were carried with the catalysts from table 1. The monomers where polymerized in a batch reactor with a volume of 1 L using a pressure of 7 bars of ethylene (C2) and propylene (C3) at 90° C. and polymerizing for 10 minutes in pentamethylheptane (PMH). The catalysts from table 1 were used in an amount of 0.07 μmol unless stated otherwise. The ratio of ethylene/propylene was 400/200 nL/hr. The polymerizations were done in the presence of 84.1 mmol ENB, 84.1 mmol VNB, 0.14 μmol tritylium tetrakis(perfluorophenyl)borate, 450 μmol ztiisobutylaluminium and 900 μmol 4-methyl-2,6-di-tert-butylphenol. Hydrogen was used as chain transfer agent with 0.35 nL/hr. The polymerization results are shown in table 2.

TABLE 2

| Example | Activity | C2 | C3 | ENB | VNB | Mw | Mn | |
|---|---|---|---|---|---|---|---|---|
| (catalyst) | [*] | [%] | [%] | [%] | [%] | [kg/mol] | [kg/mol] | Mw/Mn |
| Comparative | 1167 | 44.7 | 53.4 | 1.15 | 0.73 | 486 | 223 | 2.2 |
| Example 7 | | | | | | | | |
| (compound 297) | | | | | | | | |
| Comparative | 673 | 47.2 | 50.7 | 1.20 | 0.86 | 570 | 260 | 2.2 |
| Example 8 | | | | | | | | |
| (compound 296) | | | | | | | | |
| Comparative | 1456 | 44.5 | 53.7 | 1.07 | 0.77 | 487 | 219 | 2.2 |
| Example 9 | | | | | | | | |
| (compound 288) | | | | | | | | |
| Comparative | 1334 | 48.5 | 49.2 | 1.07 | 0.76 | 576 | 267 | 2.1 |
| Example 10 | | | | | | | | |
| (compound 291) | | | | | | | | |
| Example 7 | 1046 | 45.2 | 52.7 | 1.28 | 0.89 | 535 | 237 | 2.3 |
| (compound 287) | | | | | | | | |
| Example 8 | 982 | 51.2 | 46.4 | 1.38 | 1.06 | 652 | 297 | 2.2 |
| (compound 289) | | | | | | | | |
| Example 9 | 159 | 45.3 | 53.4 | 1.02 | 0.61 | 566 | 277 | 2.0 |
| (compound 298)** | | | | | | | | |
| Example 10 | 1065 | 47.3 | 51.2 | 0.76 | 0.70 | 645 | 303 | 2.1 |
| (compound 300)** | | | | | | | | |
| Example 11 | 2029 | 46.3 | 51.9 | 1.09 | 0.65 | 572 | 275 | 2.1 |
| (compound 293)** | | | | | | | | |
| Example 12 | 1817 | 48.6 | 49.6 | 1.07 | 0.76 | 576 | 267 | 2.2 |
| (compound 292)** | | | | | | | | |

*[Kg/mol h bar];
**catalyst amount was 0.04 μmol due to strong catalyst activity

The results in table 2 show that catalysts according to the invention with at least one linear residue R₁ gave polymers with higher molecular weight compared to catalysts where both R₁ and R₂ were branched. This behaviour was observed for substituted and non-substituted residues Sub₁. It should be noted that the results of experiments 9 to 12 were obtained already with almost half of the concentration of catalyst.

1. A catalyst composition for the polymerization of oelfinic monomers comprising a metal complex corresponding to the general formula (I) 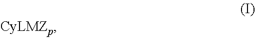
wherein
Cy represents a ligand that is bonded to the metal of the metal complex and the ligand has a cyclopentadienyl unit that is either substituted or unsubstituted,
M is the metal of the metal complex and is selected from a group 4 metal,
Z is selected independently from neutral or anionic ligands bonded to the metal M, wherein the neutral ligands are selected from conjugated dienes having from 4 to 40 carbon atoms which, optionally, may be substituted once or more than once with a substituent selected from the group consisting of hydrocarbyl, silyl, halogenated carbyl and combinations thereof, and wherein the anionic ligands are selected from the group consisting of —H, —F, —Cl, —Br, —I, -pseudohalogen, —C₁₋₁₂-alkyl, —O—C₁₋₁₂-alkyl, —C(═O)C₁₋₁₂-alkyl, -acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, all present in their anionic forms, and combinations thereof,
p is 1 or 2, and
L is an amidinate ligand of the formula (II) 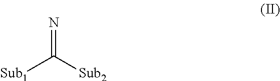
wherein the amidine-containing ligand is covalently bonded to the metal M via the imine nitrogen atom and Sub₁ represent either an aliphatic and cyclic or an aromatic substituent and Sub₁ contains from 6 to 20 carbon atoms and Sub₂ corresponds to the general formula (III) 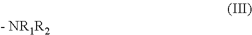
wherein R₁ and R₂ are identical or different and are selected from acyclic, linear or branched, saturated aliphatic hydrocarbon residues having from 4 to 24 carbon atoms and wherein either R₁ and R₂ are both linear or R₁ is linear and R₂ is branched and wherein the hydrocarbon chain of R₁ or R₂ may be interrupted once or more than once by an oxygen atom or a nitrogen atom, or may contain one or more halogen atoms.

2. The composition according to claim 1 wherein Sub₂ corresponds to the general formula (III) 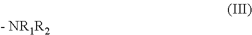
wherein R₁ is selected from n-pentyl, n-hexyl, n-heptyl, n-octyl, n-nonyl, n-decyl, n-undecyl, n-dodecyl and n-tridecyl.

3. The composition according to either claim 1 wherein wherein Sub₂ corresponds to the general formula (III) 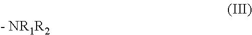
wherein R₁ and R₂ are both linear.

4. The composition according to claim 1 wherein Sub₁ represents a C₆-C₁₀ aryl residue that is unsubstituted or that is substituted and contains one or more substituents selected from halogens, C₁-C₄ alkyls, and a combination thereof.

5. The composition according to claim 1 wherein Sub₁ is a selected from phenyl and ortho-para-disubstituted phenyl with substituents selected from fluorine, C₁-C₄ alkyls, and a combination thereof.

6. The composition according to claim 1 wherein M is titanium.

7. The composition according to claim 1 wherein p is 2 and each Z represents methyl in anionic form.

8. The composition according to claim 1 wherein Cy represents a cyclopentadienyl that is substituted by one or more substituents independently selected from the group consisting of N- or S-heterocyclic substituents, C₁₋₂₀-linear, branched or cyclic alkyl substituents, C₆-C₁₂ aryl substituents, and silanes, wherein substituents may be unsubstituted or may be substituted themselves by one or more halogens, one or more C₁ to C₁₀ linear or branched alkyls, one or more C₁ to C₁₀ linear or branched oxoalkyls, C₅-C₁₀-cycloalkyls, dialkylamino groups with C₁ to C₆ alkyls, and combinations thereof.

9. The composition according to claim 1 wherein Cy is a substituted cyclopentadienyl selected from the group consisting of
(i) cyclopentandienyls that contain from 1 to 5 substituents selected from —CH₃, —CH₂CH₃, —CH₂CH₂CH₃, —CH(CH₃)₂, —C₄H₉, —C₆H₁₃, fluoromethyl, difluoromethyl, trifluoromethyl methoxymethyl, and combinations thereof;
(ii) cyclic substituted cyclopentadienyls selected from unsubstituted indenyl, unsubstituted fluorenyl, substituted indenyls, and substituted fluorenyls, wherein the substituents are selected from one or more halogens, one or more C₁ to C₁₀ linear or branched alkyls, C₅-C₁₀-cycloalkyls, dialkylamino groups with C₁ to C₆ alkyls, and combinations thereof;
(iii) N-heterocyclic substituted cyclopentadienyls corresponding to formula (1): 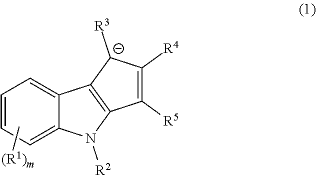
wherein
R¹ represents for each index m individually a C₁-C₄-alkyl that substitutes a hydrogen atom of the benzene ring,
m is a number of 0 to 4,
R² represents C₁-C₁₀-alkyl, C₅-C₁₀-cycloalkyl, C₆-C₁₀-aryl which is either unsubstituted or substituted with one or more C₁-C₁₀-alkyl groups, one or more C₁-C₄-dialkyl amino groups, or a combination thereof,
R³, R⁴ and R⁵ are hydrogen, C₁-C₄-alkyl, or C₆-C₁₀-aryl;
(iv) S-heterocyclic substituted cyclopentadienyls according to formula (2) 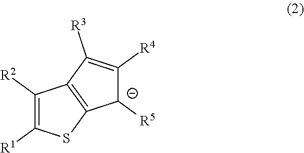
wherein
R¹ and R² are selected independently from one another from hydrogen, halogen, C₁-C₁₀ alkyl, C₅-C₁₀ cycloalkyl, and C₆-C₁₀ aryl, or
R¹ and R², together with the 2 double bond carbon atoms of the thiophene ring they are connected to, form an unsubstituted or C₁-C₄-alkyl substituted aliphatic C₅-C₆-cycloalkene ring,
R³, R⁴ and R⁵ are selected independently from each other from hydrogen, C₁-C₄ alkyl, and C₆-C₁₀-aryl.

10. The composition according to claim 1 wherein Cy is selected from methylcyclopentadienyl, dimethylcyclopentadienyl, trimethylcyclopentadienyl, tetramethylcyclopentadienyl, and pentamethylcyclopentadienyl.

11. A process for preparing a polymer comprising units derived from ethylene wherein the process comprises
(a) providing a monomer composition comprising ethylene;
(b) providing the catalyst composition comprising the metal complex;
(c) optionally, providing at least one scavenger;
(d) optionally, providing at least one activator; and
(e) contacting at least a fraction of the monomer composition with the catalyst composition to produce a polymer.

12. The process of claim 11 wherein the polymer is an ethylene/alpha-olefin copolymer and the monomer composition comprises ethylene, propylene and at least one non-conjugated diene having from 6 to 30 carbon atoms.

13. A polymer obtained by the process of claim 11.

14. Article comprising a cured polymer wherein the polymer is obtained by the process of claim 11.

15. Method of using a metal complex as defined in claim 1 as polymerization catalyst for producing a polymer comprising units derived from ethylene.

16. A process for preparing a polymer comprising units derived from ethylene wherein the process comprises
(a) providing a monomer composition comprising ethylene;
(b) providing the catalyst composition according to claim 1 comprising the metal complex;
(c) optionally, providing at least one scavenger;
(d) optionally, providing at least one activator; and
(e) contacting at least a fraction of the monomer composition with the catalyst composition to produce a polymer.
